(19) United States
(12) Patent Application Publication
(10) Pub. No.: US 2014/0358667 A1
(43) Pub. Date: Dec. 4, 2014

(54) METHODS AND APPARATUS TO EVALUATE ADVERTISING CAMPAIGNS

(71) Applicant: Daniel Alexander Beltramo, JR., Menlo Park, CA (US)

(72) Inventor: Daniel Alexander Beltramo, JR., Menlo Park, CA (US)

(21) Appl. No.: 14/138,858

(22) Filed: Dec. 23, 2013

Related U.S. Application Data
(60) Provisional application No. 61/828,512, filed on May 29, 2013.

(51) Int. Cl. G06Q 30/02

(52) U.S. Cl. CPC G06Q 30/0243
USPC 705/14.42

(57) ABSTRACT

Methods, apparatus, systems and articles of manufacture are disclosed to evaluate advertising campaigns. An example method disclosed herein includes calculating a first coordinate value based on a first effectiveness value and a first audience qualification score associated with a first advertising campaign, calculating a second coordinate value based on a second effectiveness value and a second audience qualification score associated with a second advertising campaign, identifying an apex score indicative of a maximum potential effectiveness value and a maximum potential audience qualification score, calculating a first improvement value based on a distance between the first coordinate value and the apex score, and calculating a second improvement value based on a distance between the second coordinate value and the apex score, and determining whether to adjust the first advertising campaign or the second advertising campaign based on a comparison between the first improvement value and the second improvement value.

### FIELD OF THE DISCLOSURE

This disclosure relates generally to market research, and, more particularly, to methods and apparatus to evaluate advertising campaigns.

### BACKGROUND

A substantial amount of money is invested in advertising for goods and/or services in an effort to bolster purchase and/or consumption of such goods and/or services. Regardless of a degree of quality associated with the advertised goods and/or services, if the advertising fails to reach an appropriate audience, or if the advertising fails to promote a desired objective, then such advertising investment(s) are wasted.

### BRIEF DESCRIPTION OF THE DRAWINGS

FIG. 1 is an example plot illustrating an intersection between brand lift and audience delivery.

FIG. 2A is an example chart of brand building and brand degradation.

FIGS. 2B, 3 and 4 are example charts of persuasion frontiers.

FIG. 5 is a schematic illustration of an example advertising campaign evaluator constructed in accordance with the teachings of this disclosure.

FIGS. 6-8 are flowcharts representative of example machine readable instructions that may be executed to implement the example advertising campaign evaluator of FIG. 5.

FIG. 9 is a schematic illustration of an example processor platform that may execute the instructions of FIGS. 6-8 to implement the example campaign evaluator of FIG. 5.

### DETAILED DESCRIPTION

At least three drivers influence an outcome of an advertising campaign. First, the advertising campaign should target an audience that is qualified (e.g., persons with purchasing power and having an interest in the product). Second, the advertising campaign should target an audience that is not already predisposed to agree with an advertising message or objective (e.g., in order to achieve sales beyond those that would occur even without the campaign). Third, the creative aspect of the advertising campaign must persuade the qualified and non-pre-disposed portion of the audience to purchase the product.

The first driver influence requires a focus on a target audience that has both a need/desire for the product/service and an associated ability to act on that need or desire. Historically, the target audience was defined by broad demographic, geographic and/or psychographic considerations, which resulted in campaign exposure to people unwilling or incapable of acting in a manner consistent with the advertising campaign objective(s). For example, an advertising campaign for a Volvo® station wagon having a well-recognized safety record may be directed to men ages 18-39. While this demographic focus includes men in an age range likely to have a substantial concern for safety (e.g., starting a family), the demographic focus is also targeting many men in which such a vehicle is completely out of their price range. In other words, the campaign succeeds at convincing the target audience to agree with the campaign message, but such efforts are wasted if the target audience has no ability to act on that belief.

The second driver influence requires a focus on a target audience that is not already predisposed to agree with the advertising message/objective. For example, if the example advertising campaign described above related to promoting the safety benefits of a car is presented to an audience that already agrees with the campaign message, then such advertising efforts are wasted. In other words, presenting that particular audience with the advertising campaign is “preaching to the choir” and does not result in a change in audience behavior and/or the manner in how the promoted product/service is perceived. At the opposite extreme, in the event at least a portion of the audience was either unaware or not in agreement with the campaign message (e.g., that the Volvo® car brand is a safe automobile), then the advertising efforts may cause an effect in audience behavior.

The third driver influence requires a focus on the creative aspect of the advertising campaign and applying successful campaigns to one or more appropriate target audiences to reduce (e.g., minimize) waste. A degree of success associated with an advertising campaign may be determined as a function of both messaging and media. The messaging relates to the creative aspect(s) of the campaign, such as what the advertisement says and how it is said. On the other hand, the media is considered to relate to the audience selection and the choice of delivery vehicles for the advertising campaign (e.g., television, print, Internet, etc.). In the event the media is not considered together with the messaging, then the candidate advertising campaign may not be optimized, and waste may occur.

Success of an advertising campaign is a measurable parameter that may be derived through experimental design efforts. An example manner of measuring campaign success includes posing one or more questions to two separate groups of respondents that are statistically similar (e.g., preferably identical) in every relevant way, except that a control group is not exposed to the campaign creative(s) and an exposed group is exposed to that creative(s). A difference measured between the exposed and control group allows parameter values to be derived that reflect a degree of effectiveness of the creative itself. Effectiveness may be measured in connection with one or more objectives including, but not limited to awareness (e.g., how well did the campaign make the target audience aware of a message), attitudes (e.g., how well did the campaign promote the target audience attitude toward the message), favorability (e.g., how well did the campaign cause a favorable attitude toward the message), intent (e.g., how well did the campaign move purchase intent toward a sale) and preference (e.g., how well did the campaign establish a preference). Generally speaking, the above example objectives may culminate to a measurement of effectiveness or persuasion referred to as brand lift, in which brand lift is achieved in a hierarchical manner by creating awareness of a product/service, developing attitudes toward the product/service in a favorable manner, establishing a greater purchase intent and a preference for the product/service after exposure thereto. While any type of effectiveness or persuasion may be considered (e.g., engagement, breakthrough, recall, etc.) by example methods, apparatus, systems and/or articles of manufacture disclosed herein, examples related to brand lift will be discussed for convenience.

Generally speaking, brand lift represents (e.g., is a measure of a change in attitude, which occurs from exposure to an advertising campaign. In some examples, brand lift is measured either in terms of points of difference or percent change. In examples where brand lift is measured in points, then a difference between a percentage of an exposed group (E) that exhibits a desired attitude may be subtracted from a percentage of a control group (C) that exhibits the desired attitude. Example Equation 1 illustrates a first example manner of calculating brand lift.

BL=E−C Equation 1.

In the illustrated example of Equation 1, BL reflects a brand lift value in points, E reflects the persons in the exposed group having the desired characteristic, and C reflects the persons in the control group having the desired characteristic. For example, if 12% of the exposed group is aware of a new movie versus 10% of the control group, the brand lift is two percentage points (12−10=2).

In some examples, brand lift is measured in terms of a percentage change. In some examples, the point lift value may be divided by a percentage score of a control group in a manner consistent with example Equation 2 to compute brand lift.

$$BL = \frac{( E - C )}{C} . \qquad Equation 2$$

Using the example above, the brand lift would be described as 20% (i.e., 2/10).

As described above, brand lift may be used as a primary measure of in-market messaging performance (referred to as ad effectiveness in industry parlance). Still, despite a creative having abundant success in the presence of one target audience, such success may not occur in the presence of a second, different target audience, particularly if that second audience is already predisposed in a particular way and/or if that audience is not qualified (e.g., both capable and willing to act on the message delivered by the campaign). As used herein, audience qualification is referred to as “on-target percent” or “audience delivery.” Generally speaking, audience qualification is a measurable parameter that reflects a percentage of total advertising impressions that were delivered to a target audience that is agreeable to the message and capable of acting on that message (e.g., wealthy enough to afford the advertised product/service).

In an effort to reduce (e.g., minimize) waste, example methods, apparatus, systems and/or articles of manufacture disclosed herein generate a unifying metric referred to herein as “A-score” to enable improvement (e.g., optimization) of advertising efforts in view of brand lift and audience delivery. The A-score is indicative of a degree of optimization (an optimization value) of an advertising campaign. In particular, the A-score identifies a degree of relevance of an advertising campaign with regard to a set of characteristics that enable the campaign, based on persuasion, to translate into a meaningful outcome, such as sales. The A-score may be represented as a distance value from an ideal point where an advertising campaign was perfectly delivered to a desired target audience (perfect audience delivery wherein the audience was willing and capable of acting) that was perfectly persuaded by the creative aspect of the advertising campaign. This ideal point is referred to herein as the “Advertising Apex” or the “Apex score,” in which the advertising campaign achieves both complete brand lift (100 points) and 100% on-target delivery (e.g., audience delivery). In other words, complete brand lift is a theoretical maximum potential effectiveness value. Each advertising campaign may be evaluated by a distance from the Advertising Apex (e.g., an optimization value, such as the A-score). The A-score of each advertising campaign of interest is determined and/or otherwise calculated as a coordinate value based on the intersection of corresponding effectiveness scores and audience delivery scores. As such, the A-score allows different advertising campaigns to be evaluated relative to each other.

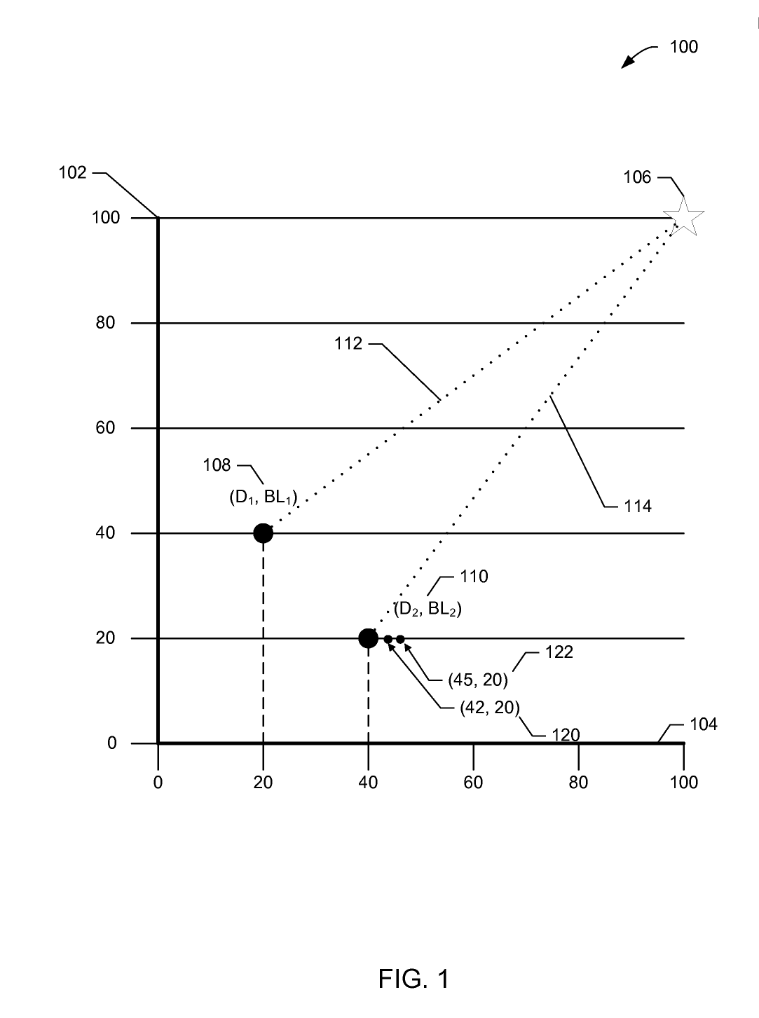

FIG. 1 is an example plot 100 of brand lift 102 (y-axis) intersecting with audience delivery (e.g., on-target percentage delivery) 104 (x-axis). In the illustrated example of FIG. 1, the brand lift 102 is normalized to values that range between zero (0) and one-hundred (100), and audience delivery 104 is normalized to values that range between zero percent (0%) and one-hundred percent (100%). An example Advertising Apex 106 illustrates a point at which brand lift and audience delivery are both at their respective maximum values. In other words, Advertising Apex 106 corresponds to a point at which theoretical advertising campaign perfection occurs where the audience is completely willing and capable of acting in a manner consistent with the campaign objective, and the entire audience was persuaded by the campaign objective.

The example plot 100 of FIG. 1 also includes a first advertising campaign 108 and a second advertising campaign 110. Each plotted advertising campaign has a corresponding A-score, which measures the distance from the example Advertising Apex 106 (the point of theoretical advertising campaign perfection). An A-score may be calculated in a manner consistent with example Equation 3.

“A−Score”={square root over (((100−D)²+(100−BL)²))} Equation 3.

In the illustrated example Equation 3, D reflects the audience delivery percentage value and BL reflects the brand lift value. The example first advertising campaign (point D₁, BL₁) 108 has a corresponding first A-score 112 and the example second advertising campaign (point D₂, BL₂) 110 has a corresponding second A-score 114.

The example first advertising campaign 108 reflects an audience delivery value of twenty (20) and a brand lift value of forty (40), while the example second advertising campaign 110 reflects an audience delivery value of forty (40) and a brand lift value of twenty (20). As such, the example first advertising campaign 108 positively persuaded more people than the example second advertising campaign 110. However, the audience associated with the first example advertising campaign 108 was less qualified than the audience associated with the second example advertising campaign 110. At least one conclusion that the comparison of the example A-scores enables is that while the example first advertising campaign 108 was able to persuade more people when compared to the example second advertising campaign 110, such persuasion occurred with an audience less able to act in a manner desired by the advertiser.

Differences between advertising campaigns may be expressed as a variance. However, the example variance between the first example advertising campaign 108 and the second example advertising campaign 110 is zero in the illustrated example of FIG. 1 because the first A-score 112 (distance) is equal to the second A-score 114 (distance). Nonetheless, despite the equality of the A-score values, example methods, apparatus, systems and/or articles of manufacture disclosed herein enable qualities of each advertising campaign to be revealed, thereby allowing campaign managers to act in a manner that improves (e.g., optimizes) advertising efforts. For example, the first example advertising campaign 108 may have a relatively higher brand lift based on the associated quality or monetary investment of the creative aspects, which may be further improved (e.g., optimized) by presenting the first advertising campaign 108 to an audience having a higher audience delivery score. For instance, advertising investments may identify and/or otherwise purchase a particular time-slot of advertising space for a particular television show that will result in a greater audience delivery score. As a result, a corresponding A-score value may decrease for the first example advertising campaign 108, thereby indicating it is closer to theoretical perfection (i.e., the Advertising Apex 106).

As described above, comparing A-scores reveals an indication of variance from one advertising campaign to another advertising campaign. In other words, the A-scores provide a metric by which advertising campaigns may be compared. However, in some examples the variance between A-score values may be low and/or otherwise difficult to distinguish because the difference between A-score values occurs in lengthy significant digits of the compared A-score values. For instance, the illustrated example of FIG. 1 includes a third advertising campaign 120 and a fourth advertising campaign 122. The example third advertising campaign 120 includes an audience delivery value of forty-two (42) and a brand lift value of twenty (20), and the example fourth advertising campaign 122 includes an audience delivery value of forty-five (45) and a brand lift value of twenty (20). Using example Equation 3, the A-score for the third advertising campaign 120 is 98.812, while the A-score for the fourth advertising campaign 122 is 97.082. The mathematical difference between these two advertising campaigns is 1.73 units. In other words, the difference in the Euclidian distance (A-score) between these two campaigns is numerically small.

To identify differences between advertising campaigns having numerical values that are relatively larger and, thus, easier to identify, example methods, apparatus, systems and/or articles of manufacture disclosed herein calculate and/or otherwise recalculate an A-score via an area calculation of the effectiveness measure (e.g., the brand lift) 102 and the audience delivery (e.g., the on-target percent) 104. For example, the A-score for the third advertising campaign 120 is calculated as the product of the audience delivery value (i.e., 42) and the brand lift (i.e., 20) to yield an A-score value of 840. Additionally, the A-score for the fourth advertising campaign 122 is calculated as the product of the audience delivery value (i.e., 45) and the brand lift (i.e., 20) to yield an A-score value of 900. As a result of calculating the A-scores for the example third campaign 120 and fourth campaign 122 via an area calculation rather than the Euclidian distance (e.g., Equation 3), a difference of sixty units between the campaigns is realized.

In some examples, A-score calculations using a Euclidian distance technique are employed unless unit difference values fall below a threshold value. For example, if A-score difference values between advertising campaigns of interest are below five, then example methods, apparatus, systems and/or articles of manufacture disclosed herein may employ an area-based technique for determining A-score values for each of the advertising campaigns of interest.

Once A-score values for one or more advertising campaigns of interest are identified, the market researcher (e.g., media buyer, campaign manager, brand manager, advertiser, etc.) may consider a manner of improving (e.g., optimizing) the advertising campaigns of interest. Such improvements may involve improving (e.g., increasing) brand lift scores and/or audience delivery scores. Improving the audience delivery (e.g., on-target percent) is typically achieved by purchasing media that is measured and/or known to exhibit relatively high concentrations of a target audience demographic characteristic. In other words, improving the audience delivery may be realized as a balance between cost and breadth of reach. Improving the brand lift may be realized by increasing focus on a level of predisposition of the audience, as described in further detail below. Accordingly, in the event a market researcher has a limited budget that cannot afford improving the audience delivery, then A-score improvements may be focused to a greater degree on audience predisposition. On the other hand, in the event the market researcher does not have control and/or does not otherwise know a degree of predisposition of the audience, then A-score improvements may be focused to a greater degree on audience delivery.

Generally speaking, predisposition represents a latent receptivity of an audience (to which an advertisement is reaching) to the objective of the advertising campaign. Stated differently, if everyone who was exposed to an advertisement already agreed with the message that the advertisement was trying to convey, then the predisposition would be 100% and, thus, time and/or resources consumed in presenting the advertisement would be wasted. On the other hand, if no one in the audience believed the message of the advertisement in advance of seeing it, then there is a chance of converting the audience to believe-in and/or otherwise conform to a belief state consistent with the message of the advertisement.

Predisposition may be measured as a percentage of respondents of a control group (e.g., unexposed respondents) that answered one or more survey questions in a manner already consistent with the message of the advertisement. In the event a market researcher wishes to maximize and/or otherwise improve brand lift (or any other measure of effectiveness), then predisposition reflects a measure of the potential for that audience. The potential for an audience may be referred to as a persuasion frontier, and may further be defined as the curve of maximal potential brand lift given an audience predisposition. The persuasion frontier may be calculated in a manner consistent with example Equation 4.

PF=(100−P) Equation 4.

In the illustrated example Equation 4, PF reflects the persuasion frontier and P reflects the measure of predisposition of the audience. In other words, the predisposition of the audience sets a limit of how much any brand lift may occur with an advertising campaign of interest because one cannot convince someone already convinced of the point being advanced.

A persuasion floor is the opposite of the persuasion frontier, in that the former bounds the potential damage that could result from destructive advertising. The persuasion floor may be calculated in a manner consistent with example Equation 5.

PF1=−P Equation 5.

In the illustrated example Equation 5, PFₗ reflects the persuasion floor and P reflects the measure of predisposition of the audience. In some examples, negative word of mouth or negative public relations contribute to destructive advertising. Every advertising campaign will have a corresponding brand lift value and predisposition that resides within a playing field bounded between the persuasion frontier and the persuasion floor.

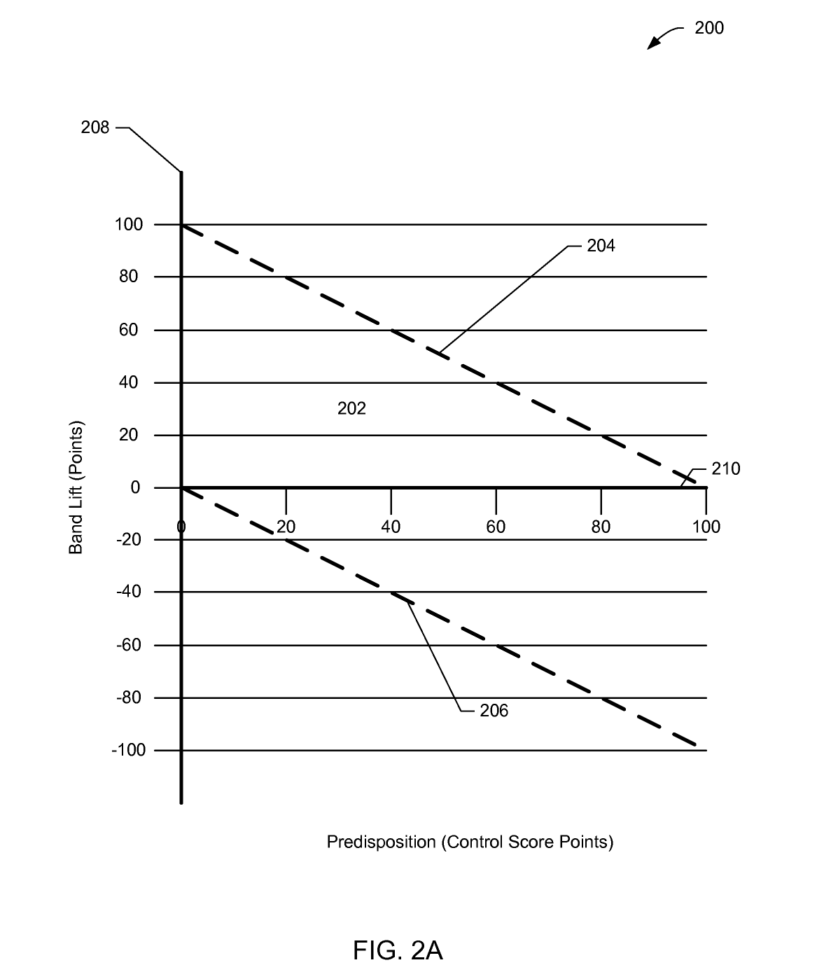

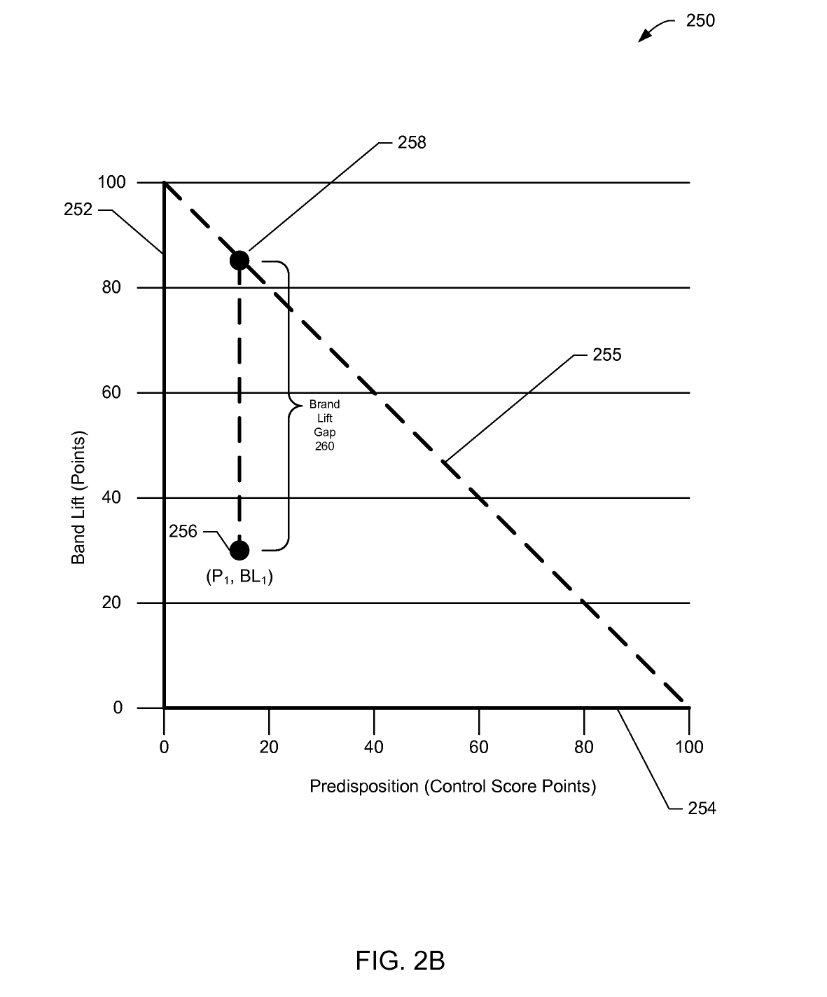

FIG. 2A illustrates an example chart 200 having a playing field 202 that is bounded by a persuasion frontier 204 and a persuasion floor 206. In the illustrated example of FIG. 2, the chart 200 includes a y-axis reflecting a level of brand lift (effectiveness) 208 and an x-axis reflecting a level of predisposition 210. The example area above the x-axis 210 reflects a potential for brand building, while the example area below the x-axis 210 reflects a potential for brand degradation.

A measure of advertising campaign performance that may be revealed via an intersection of predisposition and brand lift is referred to as a persuasion efficiency. Persuasion efficiency measures a degree of potential persuasion that may be achieved by an advertising campaign given a degree of predisposition of an audience exposed to that campaign. FIG. 2B illustrates an example chart 250 of a persuasion frontier having a y-axis reflecting a level of brand lift 252, an x-axis reflecting a level of predisposition 254, and a persuasion frontier 255. In the illustrated example of FIG. 2B, an advertising campaign point 256 has an audience predisposition of approximately 18 units (e.g., 18%) and a brand lift value of approximately 30 units. Another manner of describing an audience that is 18% predisposed is to refer to 18% of the audience having a belief or agreement with the message (e.g., objective) of the advertising campaign prior to exposure of the campaign.

In the illustrated example of FIG. 2B, the advertising campaign point 256 has a brand lift potential based on a magnitude of brand lift points between the advertising campaign point 256 (i.e., approximately 30) and the persuasion frontier 255 at a given level of predisposition, which is shown as BLP 258. The distance between the advertising campaign point 256 and the BLP 258 is a brand lift gap 260. The persuasion efficiency may be calculated in a manner consistent with example Equation 6.

$$PE = \frac{BL}{( 100 - P )} . \qquad Equation 6$$

In the illustrated example of Equation 6, PE reflects the persuasion efficiency, BL reflects a brand lift of the advertising campaign, and P reflects the predisposition. The persuasion efficiency is the ratio of the brand lift to the brand lift potential, and reflects a maximum potential brand lift (e.g., a maximum potential effectiveness, a value indicative of improvement that could be achieved) that could be achieved given that a portion of the audience already holds a desired belief that is consistent with the advertising campaign (i.e., that portion of the audience cannot be converted to agreement with the message of the campaign by the advertising campaign because they already agree with it).

The persuasion efficiency allows a comparison of an overall effectiveness of advertising campaigns across other campaigns (e.g., for different brands) that may have different objectives and/or audience profiles. For example, a major candy manufacturer (e.g., M&M's™) may have more difficulty moving awareness of its brand by one unit (e.g., one normalized point) as compared to a new candy manufacturer because the major manufacturer already has a relatively large market presence. In other words, identifying a target audience that is not already aware of the M&M's™ brand may be difficult, but identifying a target audience that is not already aware of a relatively smaller brand or manufacturer will be easier. In view of this challenge, the persuasion efficiency may reflect a maximum potential audience qualification and accounts for variance of this type. While brand lift scores for each advertising campaign have value in identifying relative degrees of persuasion from one campaign to the next, the additional insight added by persuasion efficiency considers the interplay between the audience predisposition and persuasion.

Yet another manner of evaluating advertising campaigns against each other is to measure an orthogonal distance between the example persuasion frontier and the advertising campaign. The orthogonal distance between an advertising campaign of interest and the persuasion frontier is referred to as a P-score, and may be calculated in a manner consistent with example Equation 7.

$$P - Score = [ \frac{\frac{100 - {BL}_{1} - {T}_{1}}{\sqrt{2}}}{\frac{100}{\sqrt{2}}} ] \cdot 100. \qquad Equation 7$$

In the illustrated example of Equation 7, BL₁ reflects a brand lift value for a first campaign of interest.

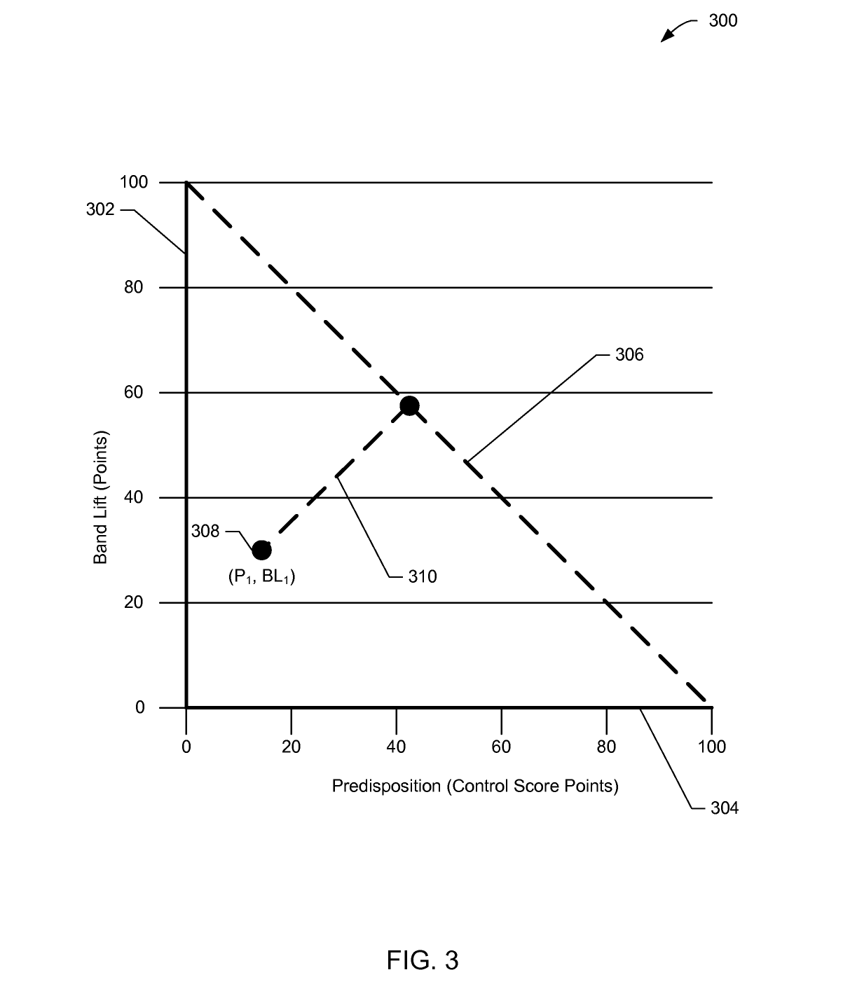

FIG. 3 illustrates an example chart 300 having a y-axis reflecting a level of brand lift (effectiveness) 302, an x-axis reflecting a level of predisposition 304, and a persuasion frontier 306. An example advertising campaign 308 has a brand lift value of approximately 18 units and a predisposition of approximately 8%. An example P-score 310 for the example advertising campaign 308 has been calculated in a manner consistent with example Equation 7 above, and reflects an orthogonal distance between the campaign 308 and the persuasion frontier 306. A perfect P-score would be zero, as it would reflect an advertising campaign that is as close to the persuasion frontier as possible. On the other hand, the worst possible P-score value would be scaled to 100 units. Relatively low P-score values indicate an audience of an advertising campaign after exposure having a desired belief state consistent with the proffered message of the campaign. Such a resulting belief state may be the result of the persuasiveness of the advertising campaign, it may be due to a predisposition, or it may be due to a combination of the persuasion of the campaign and the predisposition.

At least one benefit of P-score evaluation is that it goes beyond just a persuasiveness factor and exposes instances where a predisposed audience was found. On the one hand, delivering an advertising campaign to a relatively highly predisposed audience may be a wasteful endeavor (e.g., it limits the potential brand lift that a campaign may achieve), it may also expose circumstances in which a highly predisposed audience has been found. To that end, finding a highly predisposed audience may afford a market researcher one or more opportunities to target that audience in a more aggressive manner. In other examples, a relatively low P-score and a relatively high brand lift score may reveal that the same advertising campaign can be successfully used with a different, but similarly targeted audience.

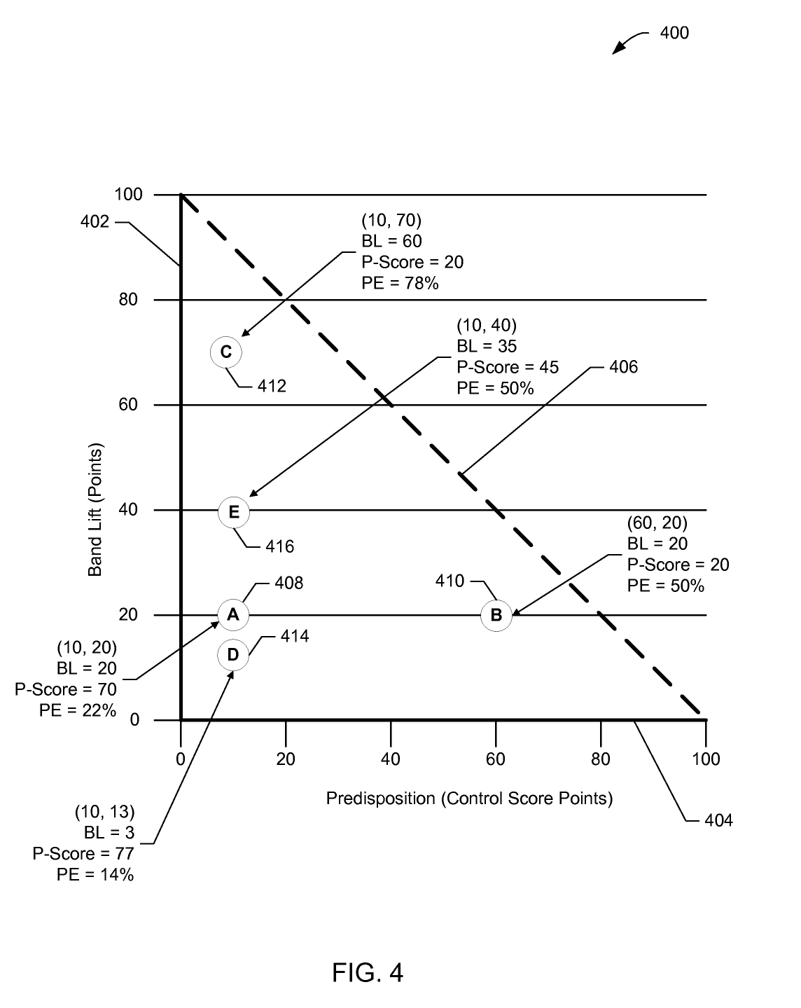

FIG. 4 illustrates an example chart 400 having a y-axis reflecting a level of brand lift (effectiveness) 402, an x-axis reflecting a level of predisposition 404, and a persuasion frontier 406. In the illustrated example of FIG. 4, the chart 400 includes a first advertising campaign (“A”) 408, a second advertising campaign (“B”) 410, a third advertising campaign (“C”) 412, a fourth advertising campaign (“D”) 414 and a fifth advertising campaign (“E”) 416. While merely evaluating a value of brand lift may reveal a degree of effectiveness for an advertising campaign, further evaluation of such advertising campaigns in view of a proximity to the example persuasion frontier 406 exposes one or more additional aspects of the campaign to allow improvement and/or selection between a number of candidate advertisements to be employed in the future.

Relative to example advertising campaign A 408, example advertising campaign B 410 has the same number of points of brand lift (i.e., 20). However, the reason that the persuasion efficiency is higher for example advertising campaign B 410 is based on the fact that it started with an audience that was more predisposed (i.e., predisposition score of 60) as compared to the audience associated with example advertising campaign A 408 (i.e., predisposition score of 10). For campaign A, an advertiser might be more likely to work on improving the creative execution of the ads that it delivers to that audience because there is relatively so much more room for improvement in terms of persuasion compared to Campaign B. On the other hand, an advertiser looking to improve upon Campaign B might choose to focus energy on reducing the cost of reaching that audience or expanding the number of similarly predisposed and qualified people given the relative persuasive efficiency of that campaign. Alternatively, Campaign B's manager could consider increasing the aggressiveness of an advertising objective, perhaps moving from building awareness with the campaign to shifting particular attitudes, purchase intent, or even preference. In some cases advertisers will benefit from increasing the persuasive qualities of their creative, maintaining the same degree of persuasion for a more aggressive objective, reducing the cost of a similarly qualified audience, and/or expanding the reach of a campaign with equal or lower cost per person of similar qualification. These tools and measures help guide the advertiser to where they may be more likely to be able to improve their advertising campaigns. Brand lift can be measured in points of raw lift over the control score or as a percentage change from the control score. Both expressions of the same basic data are useful. The percentage expression tends to be more helpful in expressing a magnitude of change, but it is influenced by the control score or its denominator. Therefore, it may be useful when comparing campaigns that are highly related to each other. Expressing brand lift in points, removes the issue of the denominator (starting point) and makes it somewhat easier to compare unrelated campaigns.

In another example, advertising campaign B 410 and advertising campaign E have identical scores for persuasion efficiency (i.e., 50%), but such scores are achieved in substantially different ways. In particular, example advertising campaign B 410 found and/or was otherwise applied to a relatively highly predisposed audience (i.e., predisposition score of 60), while example advertising campaign E 416 was highly persuasive to a relatively non-predisposed audience (i.e., predisposition score of 10).

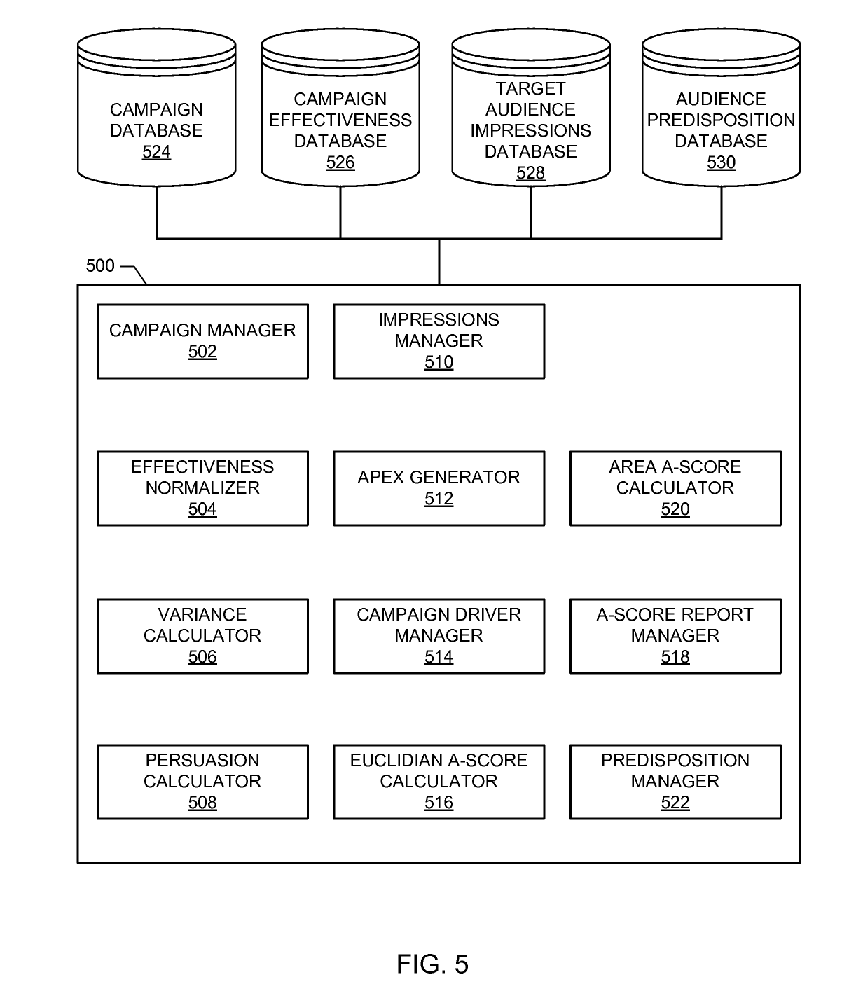

FIG. 5 is a schematic illustration of an example advertising campaign evaluator 500 constructed in accordance with the teachings of this disclosure. In the illustrated example of FIG. 5, the campaign evaluator 500 includes a campaign manager 502, an effectiveness normalizer 504, a variance calculator 506, a persuasion calculator 508, an impressions manager 510, an apex generator 512, a campaign driver manager 514, a Euclidian A-score calculator 516, an A-score report manager 518, an area A-score calculator 520 and a predisposition manager 522. The example campaign evaluator 500 is communicatively connected to an example campaign database 524, an example campaign effectiveness database 526, an example target audience impressions database 528 and an example audience predisposition database 530.

In operation, the example campaign manager 502 identifies a campaign of interest, in which data associated with one or more campaigns may be stored in the example campaign database 524. Example information stored in the campaign database 524 may include, but is not limited to, details related to a brand of the product or service promoted by the campaign, desired target audience demographics of the campaign and/or drivers associated with the campaign. As used herein, campaign drivers relate to one or more independent variables that may affect market behavior (e.g., affecting a volume of sales for a product) and may be controlled and/or otherwise manipulated by a marketing/advertising campaign. For example, an advertising campaign for a product may include a price adjustment, which is an aspect of the advertising campaign that may be controlled. Example campaign drivers may include, but are not limited to, price, distribution, all commodities volume (ACV), percent trade promotion, which agency ran the advertising campaign, which region of the country the advertising campaign was executed, which brand manager was involved, whether there was video content in the campaign, whether there was big-brand representation, etc. While a product manufacturer may control, attempt to control and/or otherwise influence one or more drivers associated with a product/service of interest, some drivers that affect market behavior are outside the control of the product manufacturer. Competitor temporary price reduction (TPR) activity, for example, is one type of driver that is beyond the control of the product manufacturer, which may affect market behavior.

The example effectiveness normalizer 504 identifies an effectiveness score associated with the selected campaign of interest. As described above, a measure of campaign effectiveness may include, but is not limited to, a score related to the campaign ability to improve awareness, to improve attitudes, to promote favorability, to instill an intent to purchase, to instill a preference and/or to raise brand lift (or recall, engagement, etc.). Data associated with the one or more metrics associated with effectiveness may be retrieved by the example effectiveness normalizer 504 from the example campaign effectiveness database 526. Additionally, because one or more different types of effectiveness metrics may have different scales and/or units of measurement, the example effectiveness normalizer 504 normalizes effectiveness scores to a scale of interest, such as a scale from zero to one-hundred. The example impressions manager 510 identifies a corresponding score of the impressions to a target audience (e.g., in terms of a percentage value).

Prior to determining an A-score associated with one or more advertising campaigns of interest, the example apex generator 512 establishes an advertising apex point of reference. As described above, the advertising apex represents an advertising campaign that achieves both complete effectiveness (e.g., a complete brand lift of 100 points/units, a maximum potential effectiveness) and is 100% on-target with delivery to the intended audience (e.g., a maximum potential audience qualification). As described in further detail below, the example Euclidian A-score calculator 516 (e.g., a distance calculator between two or more data points of interest) and/or the example area A-score calculator 520 calculate a corresponding A-score value for each campaign of interest so that they can be compared relative to each other. Relative differences between two or more advertising campaigns may be due to any number of reasons, but the reasons that may be within the control of a campaign manager are referred to herein as drivers. Each advertising campaign of interest may include one or more different driver types that may contribute to different levels of campaign success. The example campaign driver manager 514 of FIG. 5 associates each advertising campaign with at least one primary driver so that comparisons and/or analysis may be conducted on any number of different advertising campaigns. The example A-score report manager 518 generates a ranked list of the advertising campaigns of interest based on their corresponding A-score values, and identifies subsets of drivers associated with those advertising campaigns that have A-score values above a threshold value. In other words, the example A-score report manager 518 may arrange the analysis in a manner that identifies which drivers may be more common with campaigns that score relatively high on the A-score scale.

The example Euclidian A-score calculator 516 calculates an A-score value for each advertising campaign of interest based on a corresponding effectiveness score and an audience delivery score. As described above, the example Euclidian A-score calculator 516 may calculate the A-score in a manner consistent with example Equation 3, which reflects a distance between a campaign point (i.e., an intersection of the effectiveness score and the audience delivery) and the Advertising Apex. In the event a variance between each of the calculated A-score values satisfies a threshold (e.g., is lower than a threshold value), as determined by the example variance calculator 506, then the example area A-score calculator 520 is invoked to calculate the A-score. In particular, the example area A-score calculator 520 defines a campaign area value based on the area created by the intersection of the effectiveness score and the audience delivery score, as described above in connection with FIG. 1. At least one benefit to calculating A-score values based on an area instead of a Euclidian distance is that two or more campaigns that are relatively close together may reflect a relatively smaller variance when the Euclidian distance approach is employed. However, in an effort to allow easier differentiation between two or more advertising campaigns, the resulting variance from the example area A-score calculator 520 is greater than the variance resulting from example Equation 3.

As described above, another example manner of evaluating one or more advertising campaigns relative to one another includes a consideration of how appropriate an audience is that received the creative aspects of the advertisement. Considering whether an audience is already largely predisposed to believe in the message(s) conveyed by a candidate advertisement helps a market researcher know whether advertising efforts will be wasted during a campaign. The example campaign manager 502 identifies a campaign of interest, and the example effectiveness normalizer 504 identifies an associated campaign effectiveness score. Additionally, the example predisposition manager 522 identifies a predisposition score associated with the selected campaign of interest, and generates a normalized persuasion frontier, such as the example persuasion frontier 204 of FIG. 2A. The example persuasion calculator 508 calculates and/or otherwise identifies a brand lift potential based on the persuasion frontier boundary location for a selected audience predisposition value, and further calculates a brand lift gap, which reflects a difference between the selected campaign of interest and the persuasion frontier boundary. In other words, the brand lift gap illustrates a degree of opportunity the campaign efforts could have with a given audience predisposition. The example persuasion calculator 508 also calculates a persuasion efficiency that is based on a ratio of the brand lift (effectiveness) of the campaign of interest and the brand lift potential value.

Another example manner of evaluating advertising campaigns includes determining an after effect of the campaign and how closely it achieves a desired belief state. As described above, the P-score value may be calculated in a manner consistent with example Equation 7, and reflects a degree of proximity to the persuasion frontier. In other words, if the orthogonal distance between the campaign point and the persuasion frontier is relatively low, then the campaign of interest more successfully achieved the desired belief with the audience as compared to an advertising campaign having a higher P-score value (i.e., a relatively longer orthogonal distance), as described above in connection with FIG. 3.

While an example manner of implementing the advertising campaign evaluator 500 of FIG. 5 is illustrated in FIGS. 1, 2A, 2B, 3 and 4, one or more of the elements, processes and/or devices illustrated in FIGS. 1, 2A, 2B, 3, 4 and 5 may be combined, divided, re-arranged, omitted, eliminated and/or implemented in any other way. Further, the example campaign manager 502, the example effectiveness normalizer 504, the example variance calculator 506, the example persuasion calculator 508, the example impressions manager 510, the example apex generator 512, the example campaign driver manager 514, the example Euclidian A-score calculator 516, the example A-score report manager 518, the example area A-score calculator 520, the example predisposition manager 522 and/or, more generally, the example campaign evaluator 500 of FIG. 5 may be implemented by hardware, software, firmware and/or any combination of hardware, software and/or firmware. Thus, for example, any of the example campaign manager 502, the example effectiveness normalizer 504, the example variance calculator 506, the example persuasion calculator 508, the example impressions manager 510, the example apex generator 512, the example campaign driver manager 514, the example Euclidian A-score calculator 516, the example A-score report manager 518, the example area A-score calculator 520, the example predisposition manager 522 and/or, more generally, the example campaign evaluator 500 of FIG. 5 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, campaign manager 502, the example effectiveness normalizer 504, the example variance calculator 506, the example persuasion calculator 508, the example impressions manager 510, the example apex generator 512, the example campaign driver manager 514, the example Euclidian A-score calculator 516, the example A-score report manager 518, the example area A-score calculator 520, the example predisposition manager 522 and/or, more generally, the example campaign evaluator 500 of FIG. 5 is/are hereby expressly defined to include a tangible computer readable storage device or storage disk such as a memory, a digital versatile disk (DVD), a compact disk (CD), a Blu-ray disk, etc. storing the software and/or firmware. Further still, the example campaign evaluator 500 of FIG. 5 may include one or more elements, processes and/or devices in addition to, or instead of, those illustrated in FIGS. 1, 2A, 2B, 3, 4 and 5 and/or may include more than one of any or all of the illustrated elements, processes and devices.

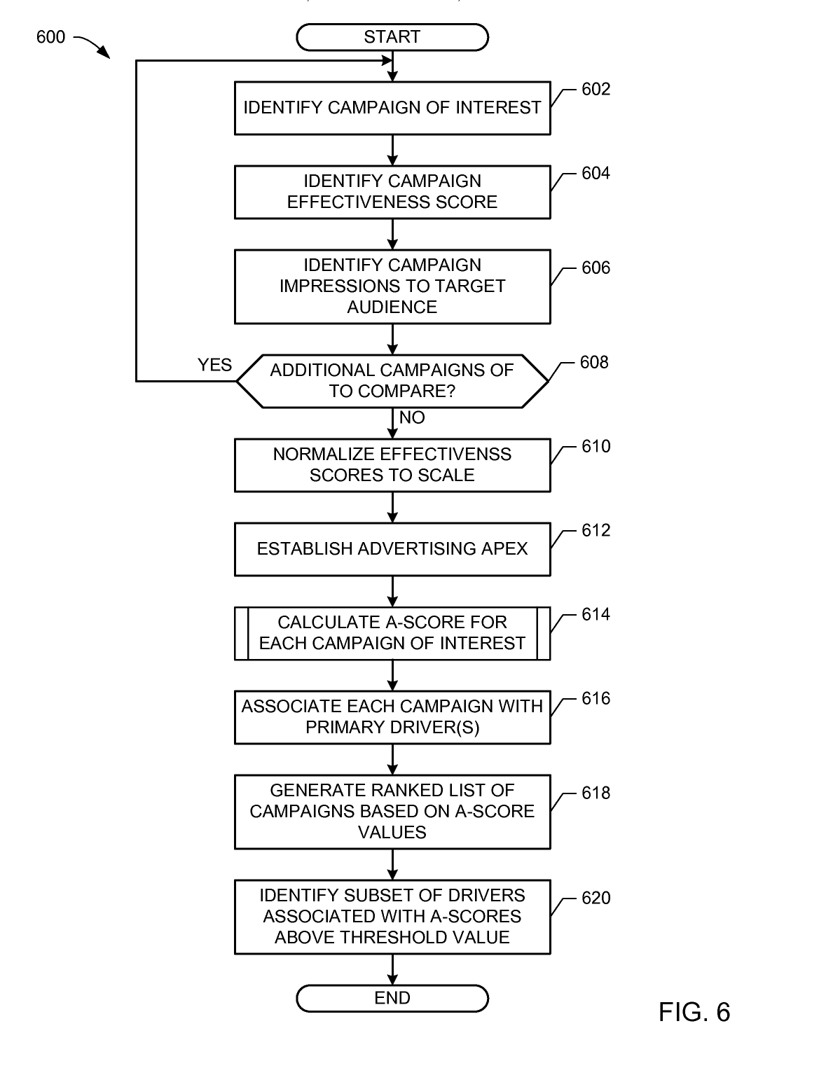

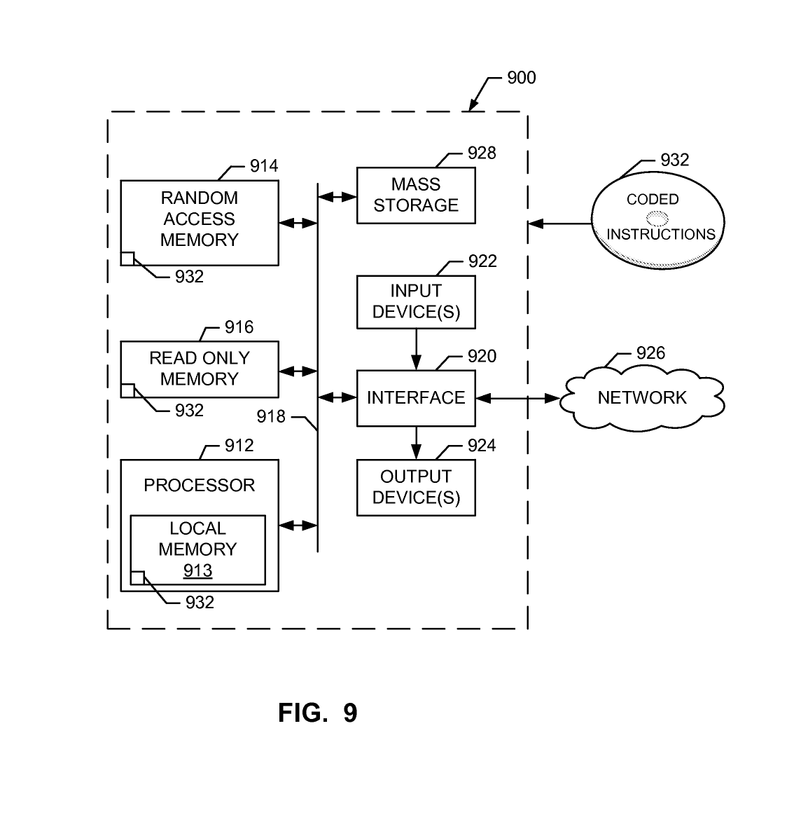

A flowchart representative of example machine readable instructions for implementing the campaign evaluator 500 of FIG. 5 is shown in FIGS. 6-8. In these examples, the machine readable instructions comprise one or more programs for execution by a processor such as the processor 912 shown in the example processor platform 900 discussed below in connection with FIG. 9. The program(s) may be embodied in software stored on a tangible computer readable storage medium such as a CD-ROM, a floppy disk, a hard drive, a digital versatile disk (DVD), a Blu-ray disk, or a memory associated with the processor 912, but the entire program(s) and/or parts thereof could alternatively be executed by a device other than the processor 912 and/or embodied in firmware or dedicated hardware. Further, although the example programs are described with reference to the flowchart illustrated in FIGS. 6-8, many other methods of implementing the example campaign evaluator 500 may alternatively be used. For example, the order of execution of the blocks may be changed, and/or some of the blocks described may be changed, eliminated, or combined.

As mentioned above, the example processes of FIGS. 6-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 6-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 600 of FIG. 6 begins at block 602, in which the example campaign manager 502 identifies and/or otherwise selects a campaign of interest. The example effectiveness normalizer 504 identifies a corresponding effectiveness score (block 604), and the example impressions manager 510 identifies a value associated with the campaign impressions to a target audience (block 606), such as a percentage value of the audience delivery. As described above, the example effectiveness score and/or the example audience delivery score may be retrieved from the example campaign effectiveness database 526 and the example target audience impressions database 528, respectively. Example methods, apparatus, systems and/or articles of manufacture disclosed herein allow for relative comparisons between two or more advertising campaigns of interest to evaluate corresponding strengths, weaknesses and/or characteristics associated with each campaign of interest. As such, the example campaign manager 502 determines whether one or more additional advertising campaigns of interest are to be included in a comparison (block 608). If so, then control returns to block 602.

When a set of advertising campaigns of interest has been identified for relative comparison (block 608), the example effectiveness normalizer 504 normalizes effectiveness scores for each of the advertising campaigns of interest to share a common scale (block 610), such as a scale ranging from zero to one-hundred. Any number of individual advertising campaigns may be compared in a relative manner, such as the advertising campaigns shown in FIG. 1 (i.e., the example first advertising campaign 108 and the example second advertising campaign 110), in which each campaign of interest is scored relative to an advertising apex generated by the example apex generator 512 (block 612). The example Euclidian A-score calculator 516 and/or the example area A-score calculator 520 calculate corresponding A-score values for each campaign of interest (block 614), as described above and in further detail below.

Because advertising campaigns include one or more drivers that may be responsible for one or more A-score values, the example campaign driver manager 514 cultivates driver information and/or primary driver information associated with each advertising campaign (block 616). To identify one or more associations between particular drivers and/or driver types, the example A-score report manager 518 generates a ranked list of advertising campaigns based on corresponding A-score values (block 618), and the example campaign driver manager 514 identifies one or more subsets of drivers associated with A-score values that are above a threshold value (block 620). In other words, the campaign manager may more readily identify which driver types are responsible for relatively higher A-score values for one or more advertising campaigns. Such information may be useful when repeating an advertising campaign with another audience in an effort to improve an effectiveness metric of the advertising campaign.

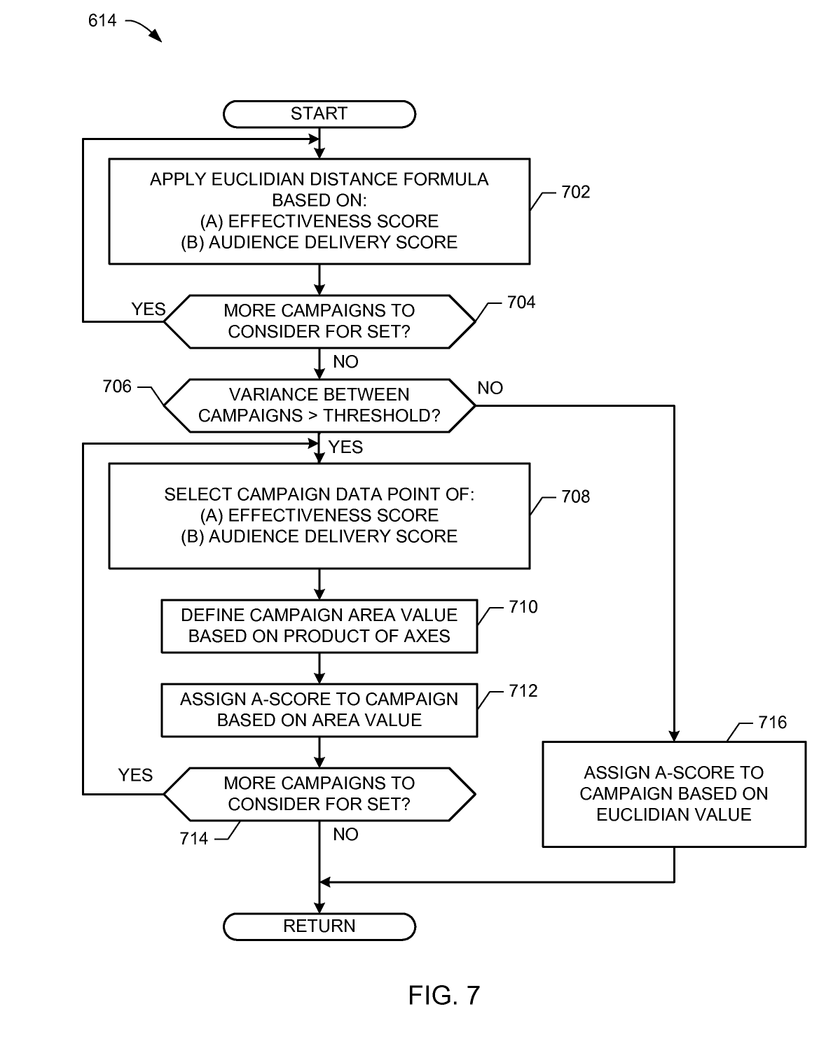

FIG. 7 illustrates additional detail associated with calculating the A-score value for one or more advertising campaigns of interest (block 614). In the illustrated example of FIG. 7, the Euclidian A-score calculator 516 calculates an A-score value for an advertising campaign of interest based on a corresponding effectiveness score and an audience delivery score (block 702). In the event additional advertising campaigns of interest are to be considered/evaluated (block 704), control returns to block 702. However, after A-score values for a set of advertising campaigns of interest has been calculated (block 704), the example variance calculator 506 determines whether a variance between two or more A-score values is less than a threshold value (block 706). For example, if an example first advertising campaign has an A-score value of 97.12 (as measured via a Euclidian distance) and an example second advertising campaign has an A-score value of 97.53 (as measured via a Euclidian distance), then any differences therebetween are identified in the first decimal digit of those results. Such relatively low variance may cause interpretive difficulty for a market researcher (e.g., a marketing manager, an advertising campaign manager, etc.) to distinguish differences between the example first and second advertising campaigns.

If the variance between campaigns falls below a threshold value (e.g., less than a unit value of 1.0, less than a unit value of 0.85, etc.) (block 706), then the example area A-score calculator 520 identifies a corresponding effectiveness score and audience delivery percentage score (block 708) and defines a campaign area value based on the area created by that intersection (block 710), as described above in connection with FIG. 1. The example campaign manager 502 assigns the A-score value to the advertising campaign of interest based on the calculated area (block 712) and if more advertising campaigns of interest are to be calculated (block 714), control returns to block 708. On the other hand, in the event the variance between two or more advertising campaigns is not below a threshold value (block 706), then the example campaign manager 502 assigns the A-score value to the advertising campaign(s) of interest using the Euclidian distance result(s) (block 716).

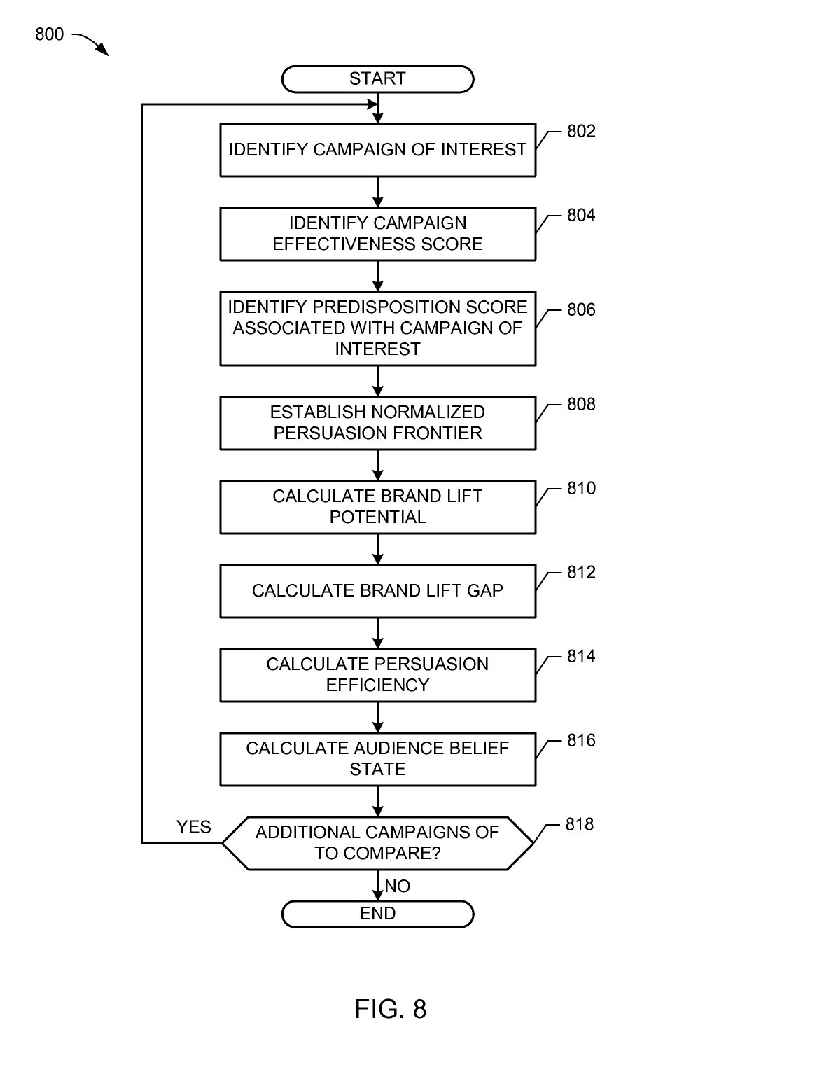

The program 800 of FIG. 8 begins at block 802, in which the example campaign manager 502 identifies a campaign of interest, and the example effectiveness normalizer 504 identifies an effectiveness score associated with the selected campaign of interest (block 804). As described above, a measure of campaign effectiveness may include, but is not limited to a score related to the campaign ability to improve awareness, to improve attitudes, to promote favorability, to instill an intent to purchase, to instill a preference and/or to raise brand lift. Data associated with the one or more metrics associated with effectiveness may be retrieved and/or otherwise identified by the example effectiveness normalizer 504 from the example campaign effectiveness database 526 (block 804). Additionally, because one or more different types of effectiveness metrics may have different scales and/or units of measurement, the example effectiveness normalizer 504 normalizes effectiveness scores to a scale of interest, such as a scale from zero to one-hundred.

The example predisposition manager 522 identifies a predisposition score associated with the selected campaign of interest (block 806), and generates a normalized persuasion frontier (block 808), such as the example persuasion frontier 204 of FIG. 2A. The example persuasion calculator 508 calculates and/or otherwise identifies a brand lift potential based on the persuasion frontier boundary location for a selected audience predisposition value (block 810), and further calculates a brand lift gap (block 812), which reflects a difference between the selected campaign of interest and the persuasion frontier boundary. The example persuasion calculator 508 also calculates a persuasion efficiency that is based on a ratio of the brand lift (effectiveness) of the campaign of interest and the brand lift potential value (block 814).

To determine an after effect of the campaign regarding how closely it has achieved a desired belief state, the example persuasion calculator 508 calculates a P-score in a manner consistent with example Equation 7 (block 816). As described above, the P-score reflects how closely the advertising campaign is to the persuasion frontier, which signifies a maximum benefit that any advertising campaign can achieve with a given audience. In the event one or more additional advertising campaigns of interest are to be evaluated (block 818), then control returns to block 802.

FIG. 9 is a block diagram of an example processor platform 900 capable of executing the instructions of FIGS. 6-8 to implement the advertising campaign evaluator 500 of FIG. 5. The processor platform 900 can be, for example, a server, a personal computer, an Internet appliance, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIGS. 6-8 may be stored in the mass storage device 928, in the volatile memory 914, in the non-volatile memory 916, and/or on a removable tangible computer readable storage medium such as a CD or DVD.

From the foregoing, it will be appreciated that example methods, apparatus and articles of manufacture have been disclosed which provide a manner of campaign evaluation that illustrates which advertising campaigns have an opportunity to be improved (e.g., optimized), and which facets of the advertising campaigns have the most room for improvement (e.g., optimization). Examples disclosed herein offer a market researcher further insight into which advertising campaigns may have limited value from the standpoint of the type of audience exposed to that campaign. As such, the market researcher may choose to control and/or otherwise tailor the target audience in a manner that permits the creative aspect of the advertising campaign to have a greater effect over the new target audience.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to identify an improvement opportunity for first and second advertising campaigns, comprising:
calculating a first coordinate value based on a first effectiveness value and a first audience qualification score associated with the first advertising campaign;
calculating a second coordinate value based on a second effectiveness value and a second audience qualification score associated with the second advertising campaign;
identifying an apex score indicative of a maximum potential effectiveness value and a maximum potential audience qualification score;
calculating a first improvement value based on a distance between the first coordinate value and the apex score, and calculating a second improvement value based on a distance between the second coordinate value and the apex score; and
determining whether to adjust the first advertising campaign or the second advertising campaign based on a comparison between the first improvement value and the second improvement value.

2. A method as defined in claim 1, further comprising calculating a variance value between the first and the second improvement values.

3. A method as defined in claim 2, further comprising recalculating the first and the second improvement values based on an area metric when the variance value is below a threshold.

4. A method as defined in claim 1, wherein the first and the second improvement values are calculated based on a Euclidian distance from the apex score.

5. A method as defined in claim 1, further comprising ranking the first advertising campaign and the second advertising campaign based on the first and the second improvement values.

6. A method as defined in claim 5, further comprising identifying a driver type associated with a highest ranking advertising campaign improvement value.

7. A method as defined in claim 1, further comprising identifying a first predisposition score associated with the first advertising campaign and a second predisposition score associated with the second advertising campaign.

8. A method as defined in claim 7, further comprising calculating a maximum potential effectiveness value for the first advertising campaign and the second advertising campaign based on the first and the second predisposition scores, respectively.

9. A method as defined in claim 7, wherein the first predisposition score is indicative of a portion of an audience that agrees with the first advertising campaign prior to exposure thereto.

10. A method as defined in claim 1, wherein the first audience qualification score is based on a percentage of total advertising impressions delivered to a target audience associated with the first advertising campaign.

11. An apparatus to identify an improvement opportunity for first and second advertising campaigns, comprising:
a distance calculator to calculate a first coordinate value based on a first effectiveness value and a first audience qualification score associated with the first advertising campaign, and to calculate a second coordinate value based on a second effectiveness value and a second audience qualification score associated with the second advertising campaign;
an apex generator to identify an apex score indicative of a maximum potential effectiveness value and a maximum potential audience qualification score;
a persuasion calculator to calculate a first improvement value based on a distance between the first coordinate value and the apex score, and calculating a second improvement value based on a distance between the second coordinate value and the apex score; and
a campaign manager to determine whether to adjust the first advertising campaign or the second advertising campaign based on a comparison between the first improvement value and the second improvement value.

12. An apparatus as defined in claim 11, further comprising a variance calculator to calculate a variance value between the first and the second improvement values.

13. An apparatus as defined in claim 12, further comprising an area A-score calculator to recalculate the first and the second improvement values based on an area metric when the variance value is below a threshold.

14. An apparatus as defined in claim 11, wherein the distance calculator is to calculate the first and the second improvement values based on a Euclidian distance from the apex score.

15. An apparatus as defined in claim 11, further comprising a report manager to rank the first advertising campaign and the second advertising campaign based on the first and the second improvement values.

16. An apparatus as defined in claim 15, further comprising a campaign driver manager to identify a driver type associated with a highest ranking advertising campaign improvement value.

17. An apparatus as defined in claim 11, wherein the persuasion calculator is to identify a first predisposition score associated with the first advertising campaign and a second predisposition score associated with the second advertising campaign.

18. An apparatus as defined in claim 17, wherein the persuasion calculator is to calculate a maximum potential effectiveness value for the first advertising campaign and the second advertising campaign based on the first and the second predisposition scores, respectively.

19. An apparatus as defined in claim 17, wherein the first predisposition score is indicative of a portion of an audience that agrees with the first advertising campaign prior to exposure thereto.

20. An apparatus as defined in claim 11, wherein the first audience qualification score is based on a percentage of total advertising impressions delivered to a target audience associated with the first advertising campaign.

21. A tangible machine readable storage medium comprising instructions that when executed, cause a machine to, at least:
calculate a first coordinate value based on a first effectiveness value and a first audience qualification score associated with the first advertising campaign;
calculate a second coordinate value based on a second effectiveness value and a second audience qualification score associated with the second advertising campaign;
identify an apex score indicative of a maximum potential effectiveness value and a maximum potential audience qualification score;
calculate a first improvement value based on a distance between the first coordinate value and the apex score, and calculate a second improvement value based on a distance between the second coordinate value and the apex score; and
determine whether to adjust the first advertising campaign or the second advertising campaign based on a comparison between the first improvement value and the second improvement value.

22. A storage medium as defined in claim 21, wherein the instructions, when executed, further cause the machine to calculate a variance value between the first and the second improvement values.

23. A storage medium as defined in claim 22, wherein the instructions, when executed, further cause the machine to recalculate the first and the second improvement values based on an area metric when the variance value is below a threshold.

24. A storage medium as defined in claim 21, wherein the instructions, when executed, further cause the machine to calculate the first and the second improvement values based on a Euclidian distance from the apex score.

25. A storage medium as defined in claim 21, wherein the instructions, when executed, further cause the machine to rank the first advertising campaign and the second advertising campaign based on the first and the second improvement values.

26. A storage medium as defined in claim 25, wherein the instructions, when executed, further cause the machine to identify a driver type associated with a highest ranking advertising campaign improvement value.

27. A storage medium as defined in claim 21, wherein the instructions, when executed, further cause the machine to identify a first predisposition score associated with the first advertising campaign and a second predisposition score associated with the second advertising campaign.

28. A storage medium as defined in claim 27, wherein the instructions, when executed, further cause the machine to calculate a maximum potential effectiveness value for the first advertising campaign and the second advertising campaign based on the first and the second predisposition scores, respectively.
